(19) United States
(12) Patent Application Publication
(10) Pub. No.: US 2018/0095288 A1
(43) Pub. Date: Apr. 5, 2018

(54) METHOD AND SYSTEM FOR PERFORMING AN IMPROVED SUPPORT FOR 3D DISPLAYING AND CORRESPONDING SUPPORT PERFORMED

(71) Applicant: REALVISION S.R.L., Milano (IT)

(72) Inventor: Daniele DE MOLLI, Calende (IT)

(21) Appl. No.: 15/562,485

(22) PCT Filed: Apr. 1, 2016
(86) PCT No.: PCT/IB2016/051873

§ 371 Date: Sep. 28, 2017

(30) Foreign Application Priority Data
Apr. 2, 2015 (IT) MI2015A000471
Apr. 23, 2015 (IT) MI2015A000584

(51) Int. Cl. G02B 27/22; G02F 1/1335; B29D 11/00

(52) U.S. Cl. CPC G02B 27/2214; G02F 1/133512; B23K 26/0057; B29D 11/00278; H04N 13/0409; B29D 11/00634

(57) ABSTRACT

The invention discloses a method for performing a support for 3D transmission, comprising the steps of providing an unprocessed transparent support (10), performing a laser incision in the unprocessed transparent support (10) using a pulsed laser beam (21), and driving the pulsed laser beam (21) in such a manner that incising into the unprocessed transparent support (10) gives rise to areas (11a; 11b) with lower transmittance (TR_11) with respect to a transmittance (TFM O) of the unprocessed transparent support (10), the alternation of the areas (11a; 11b) with lower transmittance (TR_11) and the unprocessed transparent support (10) creating bands (B1i; B2i) that implement an autostereoscopic barrier (B1; B2). The invention further discloses a system for implementing the above-mentioned method and a transparent support with the characteristics conferred by the above-mentioned method.

### FIELD OF APPLICATION

The object of the present invention is a method for performing a support for 3D displaying.

In particular, the object of the present invention is a method for performing a support for 3D displaying by means of laser-incising.

More specifically, the object of the present invention is a method for performing a support for 3D displaying by means of laser-incising so as to perform an autostereoscopic barrier that makes it possible to view three-dimensional images without having to utilize secondary optical devices, such as a stereoscope or glasses, as the support is equipped with a system that provides for directing to each eye the image intended for each eye.

### PRIOR ART

The prior art for three-dimensional displaying comprises the arrangement of a device for transmitting three-dimensional images that transmits the images through a glass screen, and the arrangement of an additional layer of plastic material that is glued onto the screen; a series of bands has been previously moulded on this layer so as to realize a parallax effect.

The system realized by the association of the additional layer of plastic material with the device for transmitting two-dimensional images realizes a 3D displaying system.

According to the prior art described, the image transmitted by the device for transmitting two-dimensional images is filtered by the additional layer so that it can be directed to the eyes so as to render the 3D view.

A serious drawback concerning this technique is that the image transmitted by the device for transmitting two-dimensional images passes through three surfaces before reaching the user's eyes, that is, in the following order: the exit surface of the screen, the entrance surface of the additional layer and the exit surface of the additional layer.

Such transmission inevitably leads to undesirable reflections of the transmitted image at each surface its passes through, thereby deteriorating the quality of the image.

Moreover, the presence of a number of surfaces in contact with each other, makes the overall system more vulnerable in terms of keeping it clean. In fact, particulates tend to accumulate on the surfaces, which also contributes to deterioration of the quality of the image.

The result of the 3D image offered to the user risks being of poor quality, in addition to leading to visual disturbances/problems for the user.

The aim of the present invention is to provide a system/method for performing a support for 3D transmission that resolves the above-mentioned problems, overcoming the drawbacks of the prior art.

A specific aim of the present invention is to provide a system/method for performing a support for 3D transmission that ensures high quality of the transmitted image.

A further aim of the present invention is to provide a system/method for performing a support for 3D transmission that does not give rise to visual disturbances for the user.

### SUMMARY OF THE INVENTION

These and other aims are achieved by the invention according to what is set forth in the appended claims.

In a first aspect, the invention discloses a method for performing a support for 3D transmission, comprising the steps of:
arranging an unprocessed transparent support;
making a laser cut in the unprocessed transparent support using a pulsed laser beam;
driving the pulsed laser beam such that, by incising into the unprocessed transparent support, it gives rise to areas with lower transmittance with respect to a transmittance of the unprocessed transparent support, the alternation of the lower transmittance areas and the unprocessed transparent support creating bands that implement an autostereoscopic barrier.

Preferably, the laser-incising process carried out on the unprocessed transparent support using a pulsed laser beam makes parallel cuts, creating parallel bands that implement a parallax barrier.

Preferably, the laser-incising process carried out on the unprocessed transparent support using a pulsed laser beam is carried out as a function of predefined design values of first dimensions of the lower transmittance areas and of second dimensions of distances between the lower transmittance areas.

Preferably, the lower transmittance areas are characterized by an opacity and/or roughness and/or thickness differing from an opacity and/or roughness and/or thickness of the unprocessed transparent support.

Preferably, the lower transmittance areas are characterized by an opacity that is greater than an opacity of the unprocessed transparent support. In one or more of the described aspects, the lower transmittance areas are characterized by a roughness that is greater than a roughness of the unprocessed transparent support.

Preferably, the lower transmittance areas are characterized by a first thickness that is smaller than a second thickness of the unprocessed transparent support.

Preferably, the laser-incising process is carried out with the emission of pulses at intervals of time in the order of femtoseconds.

Preferably, the lower transmittance areas have a transmittance in the range of 30% to 50% of the transmittance of the unprocessed transparent support, preferably of 50%.

Preferably, the lower transmittance areas have reduced thickness, in the order of hundredths of a micron, with respect to the thickness of the unprocessed transparent support.

Preferably, the unprocessed transparent support is a transparent support made of an amorphous polymeric material or a glass material.

In a second aspect, the invention discloses a system for performing a support for 3D transmission, comprising:
an unprocessed transparent support;
a laser-incising device configured to incise the transparent support, creating a plurality of areas with lower transmittance, with respect to a transmittance of the unprocessed transparent support;
a processing unit configured to control the laser-incising device.

Preferably, the processing unit is configured to drive the laser beam as a function of predefined design values of first dimensions of the lower transmittance areas and second dimensions of distances between the lower transmittance areas.

The unprocessed transparent support is preferably one of a display of a cellular phone, a tablet or the like, or one of a screen for a PC, a TV or the like.

In a third aspect, the invention discloses a transparent support comprising:
a plurality of areas with lower transmittance with respect to a transmittance of the unprocessed transparent support, the alternation of the lower transmittance areas and the unprocessed transparent support creating bands that implement an autostereoscopic barrier.

Preferably, the transparent support comprises the plurality of lower transmittance areas on one face of the unprocessed transparent support.

Preferably, the transparent support comprises a plurality of lower transmittance areas inside the transparent support.

Preferably, the transparent support comprises one of a display of a cellular phone, a tablet or the like, or one of a screen for a PC, a TV or the like.

In one or more of the described aspects, in a first embodiment of the invention, the autostereoscopic system is a parallax barrier.

Preferably, the parallax barrier has substantially vertical bands.

Preferably, the lower transmittance areas are characterized by a first thickness that is smaller than a second thickness of the unprocessed transparent support.

In one or more of the described aspects, in a second embodiment of the invention, the autostereoscopic barrier is a lenticular barrier.

Preferably, the lenticular barrier has slanted bands.

Preferably, the lower transmittance areas are characterized by a third minimum thickness that is smaller than the second thickness of the unprocessed transparent support.

The presented aspects of the invention make it possible to perform a parallax barrier for viewing three-dimensional images without having to utilize secondary optical devices, such as a stereoscope or glasses.

The laser incision provided in the invention is applied directly to a displaying support and does not require accessories to be worn to enable a 3D visual effect for the user.

The technical effect is guaranteed by the same support, which is equipped with a system that provides for directing to each eye the image intended for each eye so as to realize a 3D view.

The technical effects/advantages cited and other technical effects/advantages of the invention will emerge in further detail from the description provided herein below of an example embodiment provided by way of approximate and non-limiting example with reference to the attached drawings.

### BRIEF DESCRIPTION OF THE DRAWINGS

FIG. 1 is a schematic view of a support for 3D transmission, in an unprocessed state according to the prior art.

FIG. 1a is a schematic view of a support for 3D transmission, in a processed state, in a first embodiment of the invention.

FIG. 1b is a schematic view of a support for 3D transmission, in a processed state, in a second embodiment of the invention.

FIG. 2a is a representation of a parallax barrier generated starting from the support appearing in FIG. 1a.

FIG. 2b is a representation of a lenticular barrier generated starting from the support appearing in FIG. 1b.

FIG. 3a is a block diagram of the system for generating the support for 3D transmission appearing in FIG. 1a from which the parallax barrier of FIG. 2a is generated.

FIG. 3b is a block diagram of the system for generating the support for 3D transmission appearing in FIG. 1b from which the lenticular barrier of FIG. 2a is generated.

FIGS. 4a and 4b are schematic views of the use of the supports for 3D transmission generated according to the first and the second embodiment of the invention, respectively.

### DETAILED DESCRIPTION

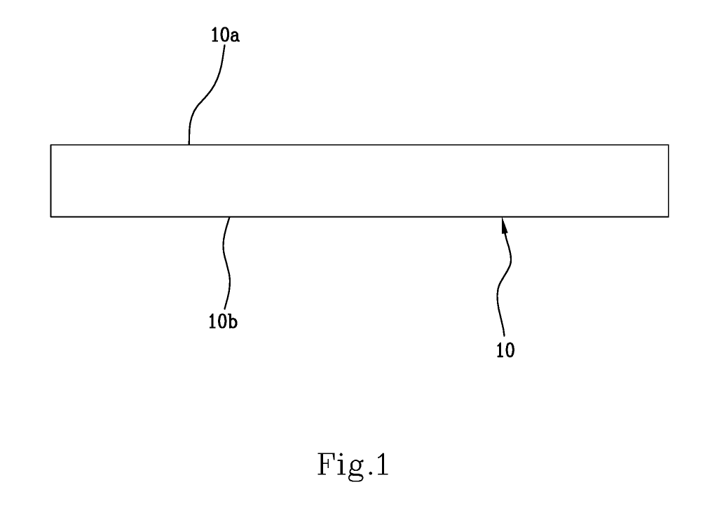

With reference to FIG. 1, the invention comprises providing an unprocessed transparent support 10.

In particular, a section of this support is shown in FIG. 1.

Preferably, this unprocessed transparent support 10 comprises an amorphous polymeric material or a glass material.

The transparent support 10 is provided for subsequent processing.

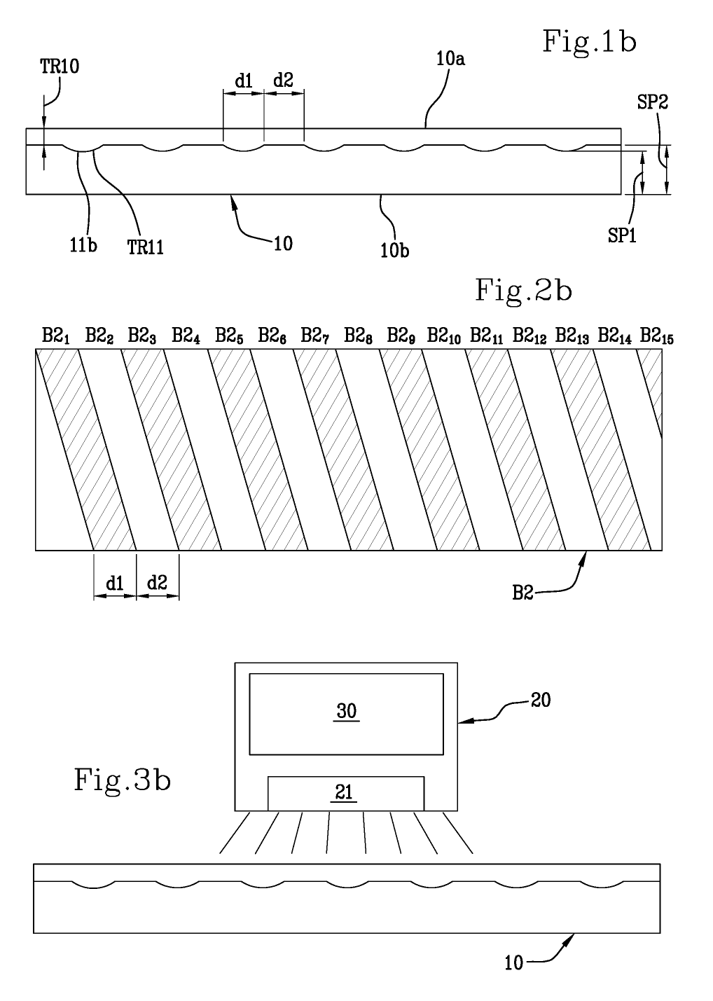

With reference to FIGS. 3a and 3b, a system is shown for performing a support for 3D transmission, starting from the unprocessed transparent support 10.

This system comprises a laser-incising device 20, configured to cut the unprocessed transparent support 10, creating a plurality of areas 11 (FIGS. 1a) and 11b (FIG. 1b) with lower transmittance TR_11, with respect to a transmittance TR_10 of the unprocessed transparent support 10.

According to the invention, a processing unit 30 is configured to control the laser-incising device 20.

The laser-incising device 20 is configured to emit a pulsed laser beam 21.

In a preferred embodiment of the invention, the laser-incising process is performed with the emission of pulses at intervals of time in the order of femtoseconds.

In particular, the processing unit 30 is configured to drive the pulsed laser beam 21 in such a manner that incising into the unprocessed transparent support 10 gives rise to areas 11a, 11b with lower transmittance TR_11 with respect to a transmittance TR_10 of the unprocessed transparent support 10.

According to the invention, the areas 11a, 11b with lower transmittance TR_11 have a transmittance in the range of 30% to 50% of the transmittance TR_10 of the unprocessed transparent support 10.

Preferably, the areas 11a, 11b with lower transmittance TR_11 have a transmittance equal to 50% of the transmittance TR_10 of the unprocessed transparent support 10.

The method comprises performing an anti-reflection treatment on the unprocessed transparent support 10, particularly on the part arranged frontally with respect to a user of the system of the invention.

Alternatively, or additionally, the method comprises performing an anti-reflection treatment of the areas 11a, 11b with lower transmittance TR_11.

Preferably, this treatment is carried out by applying an anti-reflection coating.

The technical effect achieved consists in the elimination of external visual disturbances under all light conditions of the surrounding environment.

Such an effect is of considerable importance in the medical field, where the guarantee of the sharpness and clarity of the images is synonymous with greater protection of a patient's health.

In an embodiment of the invention, the pulsed laser beam 21 cuts into one face 10a of the unprocessed transparent support 10, particularly the face facing a source of images, whereas the completely unprocessed face 10b of the support 10 faces an observer who receives the images coming from the source and filtered by the processed support 10.

In an embodiment of the invention, the pulsed laser beam 21 cuts inside the transparent support 10, as shown in all the figures.

In particular, in this case, the pulsed laser makes it possible to release the energy density inside the support after passing through a face thereof.

Advantageously, according to the invention, the alternation of the areas 11a, 11b with lower transmittance TR_11 and the unprocessed transparent support 10 creates bands B1i, B2i (i=1 . . . n) that implement an autostereoscopic system B1, B2.

The technical effect achieved consists in the implementing of an autostereoscopic barrier directly on the unprocessed transparent support without any need to apply an additional layer to the support.

Autostereoscopy frees the viewer from wearing special glasses, given that the physical structure, which enables separation of the images coming from any source, is afforded in the unprocessed transparent support 10.

In a preferred embodiment, the above-mentioned laser-incising process carried out on the unprocessed transparent support 10 makes parallel cuts, creating parallel bands B1i, B2i that implement an autostereoscopic barrier B1, B2.

The autostereoscopic barrier makes it possible to view three-dimensional images without having to utilize secondary optical devices, such as a stereoscope or glasses, as the support is equipped with a system that provides for directing to each eye the image intended for each eye; each eye sees a different set of pixels, thus creating a sense of depth through the autostereoscopic barrier with an effect similar to that which lenses suitably predisposed for eyeglasses produce.

The autostereoscopy systems according to the invention are those systems in which a parallax barrier B1 or a lenticular barrier B2 is performed on the unprocessed transparent support 10.

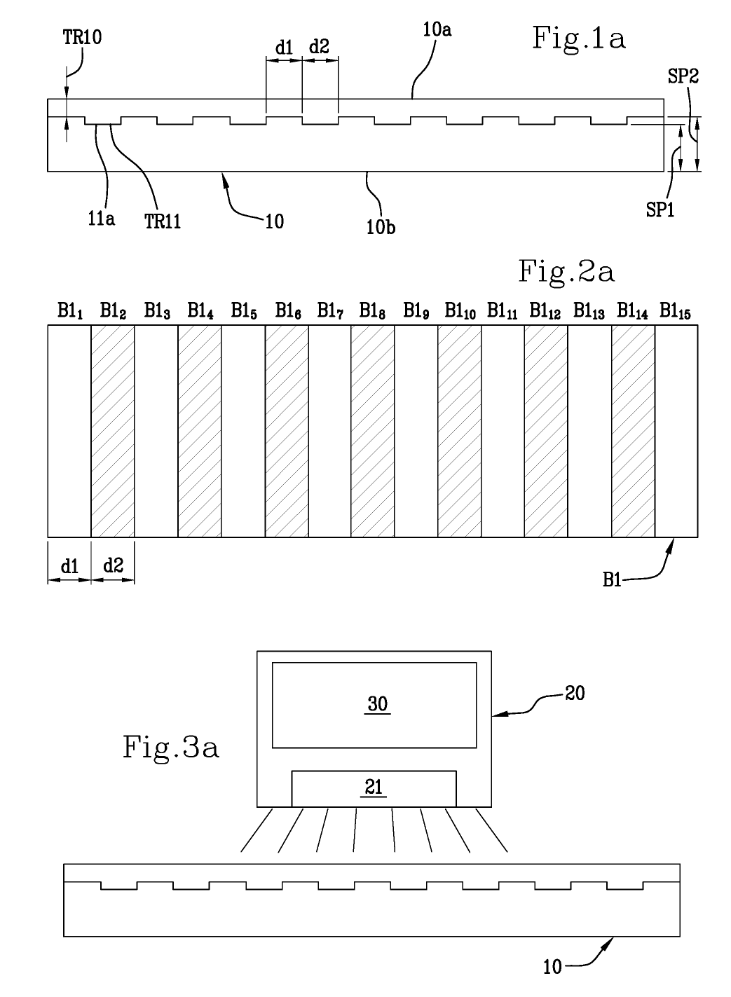

In the first embodiment of the invention (FIGS. 1a and 2a), the alternation of the areas 11a with reduced transmittance TR_11 and the unprocessed transparent support 10 creates bands B1i that implement a parallax barrier B1. These bands B1i appear as bands B1₁-B1₁₅ in FIG. 3.

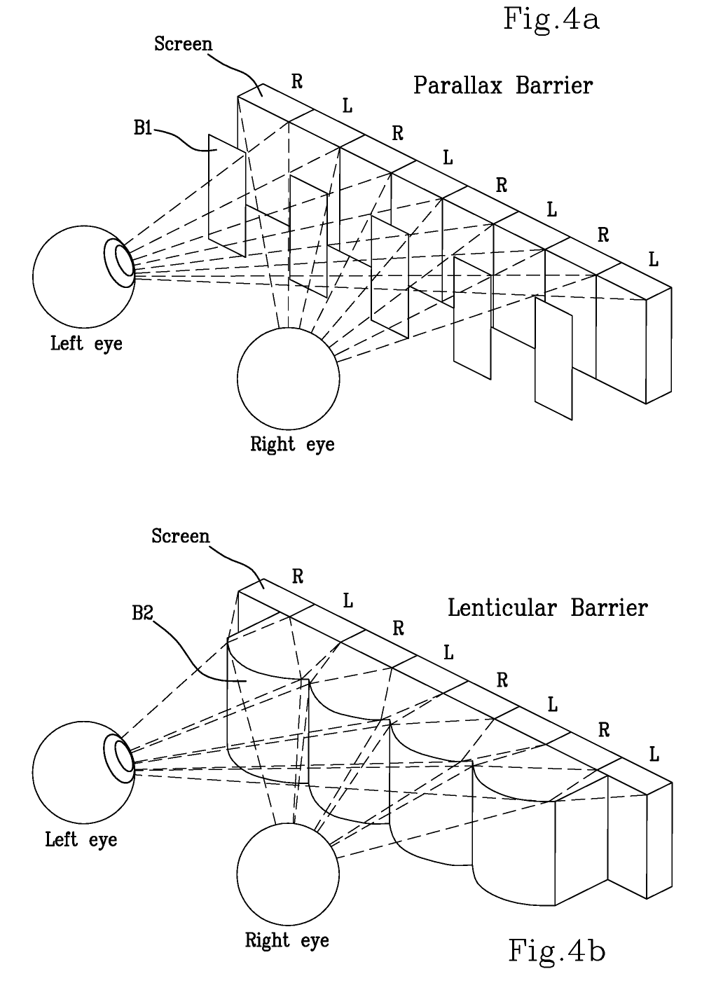

The system with the parallax barrier B1 uses selective dimming of certain columns of pixels to one of the two eyes, as well as the parallax phenomenon, as shown in FIG. 4a.

Through the parallax barrier B1, each eye shall be capable of seeing only certain columns of pixels of an image generated as input to the support 10.

Preferably, the parallax barrier B1 has substantially vertical bands (FIG. 2a).

Preferably, the parallax barrier B1 is applied to transparent supports 10 ranging from 1″ to 10″ in size, particularly cellular phones, tablets and like devices.

In this first embodiment, the cut made by the laser 20 in the unprocessed transparent support 10 creates a plurality of areas 11a with lower transmittance TR_11 and configured as parallelepiped-shaped cavities.

In the second embodiment of the invention (FIGS. 1b and 2b), the alternation of the areas 11b with lower transmittance TR_11 and the unprocessed transparent support 10 creates bands B2i that implement a lenticular barrier B2.These bands B2i appear as bands B2₁-B2₁₅ in FIG. 2b.

Through the lenticular barrier B2, each eye shall be capable of seeing only certain columns of pixels of an image generated as input to the support 10.

The lenticular barrier functions virtually in the same manner as the parallax barrier, but the lenticular barrier comprises a plurality of areas cut in a shape such as to generate an effect of cylindrical “magnifying lenses” side by side longitudinally; observing the screen from two different perspectives proper to each eye, each column of lenses will magnify and enable viewing of only specific columns of pixels, providing two different images to each eye, as shown in FIG. 4b.

Preferably, the lenticular barrier B2 has slanted bands (FIG. 2b).

Preferably, the lenticular barrier B2 is applied to transparent supports 10 ranging from 10″ to 85″, particularly monitors, TVs and like devices.

The degree of slant of the bands and the dimensions of the bands depend upon the dot pitches of the support/display.

This barrier uses the lenses that are concave in shape and cover the entire surface of the support/display slantwise, based on the dot pitches of the support/display, creating the “lens effect” only on some of the subpixels in the support/display panel.

Advantageously, in both embodiments of the invention, three-dimensional viewing for a user is carried out using a conversion device (shown in patent application WO2015/019368 filed by the same Applicant) equipped with a module that checks whether the input image to the autostereoscopic system is a double right-left channel image, and with an interlacing module configured to create a sharp and precise interlaced image of the input image to the autostereoscopic system.

With reference to the figures, the areas 11 with lower transmittance TR_11 have a first linear dimension d1, whereas the distance between the areas with lower transmittance TR_11 has a second linear dimension d2.

The alternation of the areas of dimensions d1 and d2, that is, the alternation of the bands with lower transmissivity and the areas with the unprocessed transparent support, creates the autostereoscopic barrier generated according to the invention.

In a preferred embodiment of the invention, the processing unit 30 is configured to drive the laser beam 21 as a function of predefined design values of the first dimensions d1 of said lower transmittance areas 11 and the second dimensions d2 of distances between the lower transmittance areas 11.

The design dimensions d1 and d2 are obtained from known dimensioning algorithms described in the literature.

In the first embodiment of the invention, preferably, the areas 11a with lower transmittance TR_11 are characterized by an opacity and/or roughness and/or thickness differing from an opacity and/or roughness and/or thickness of the unprocessed transparent support 10.

In a first variant of the first embodiment, the areas 11a with lower transmittance TR_11 are characterized by an opacity that is greater than an opacity of the unprocessed transparent support 10.

In a second variant of the first embodiment, the areas 11a with lower transmittance TR_11 are characterized by a roughness that is greater than a roughness of the unprocessed transparent support 10.

In a third variant of the first embodiment, the areas 11a with lower transmittance TR_11 are characterized by a first thickness sp1 that is smaller than a second thickness sp2 of the unprocessed transparent support 10.

Preferably, the first thickness sp1 of the areas 11a with lower transmittance TR_11 is in the order of hundredths of a micron, with respect to the thickness sp2 of the unprocessed transparent support 10.

In the second embodiment of the invention, the areas 11a with lower transmittance TR_11 are characterized by a third minimum thickness sp3 that is smaller than the second thickness sp2 of the unprocessed transparent support 10.

Preferably, the third thickness sp3 of the areas 11b with lower transmittance TR_11 is in the order of hundredths of a micron, with respect to the thickness sp2 of the unprocessed transparent support 10.

The invention enables the performing of a transparent support 10.

In the first preferred embodiment of the invention, the transparent support 10 comprises a display for cellular phones, tablets or like devices.

In the second preferred embodiment of the invention, the transparent support 10 comprises a screen for a PC, a TV or like devices.

The transparent support comprises a plurality of areas 11a, 11b with lower transmittance TR_11, with respect to a transmittance TR_10 of the transparent support 10.

In the second embodiment, the alternation of the areas 11a with lower transmittance TR_11 and the unprocessed transparent support 10 creates bands B1i that implement a lenticular barrier B1 for the displays of cellular phones, tablets, similar devices or any other system equipped with a display processed as disclosed in the present invention, particularly ranging from 1″ to 10″ in size.

In the second embodiment, the alternation of the areas 11b with lower transmittance TR_11 and the unprocessed transparent support 10 creates bands B2i that implement a lenticular barrier B2 for the screen of a PC, a TV or any other system equipped with a display processed as disclosed in the present invention, particularly ranging from 10″ to 85″ in size.

Preferably, the transmittance of the areas 11 with lower transmittance TR_11 is equal to about 50% of the transmittance TR_10 of the transparent support.

The technical effect of 3D displaying for cellular phones, tablets or like devices, PCs, TVs or like devices is guaranteed by the same support, which, as disclosed, is equipped with a system that provides for directing to each eye the image intended for each eye for a 3D view.

1. A method for performing a support for 3D transmission, comprising the steps of:
providing an unprocessed transparent support (10);
performing a laser incision in said unprocessed transparent support (10) using a pulsed laser beam (21);
driving said pulsed laser beam (21) in such a manner that incision into the unprocessed transparent support (10) gives rise to areas (11 a; 11 b) with lower transmittance (TR_11) with respect to a transmittance (TR_10) of said unprocessed transparent support (10), the alternation of said areas (11 a; 11 b) with lower transmittance (TR_11) and said unprocessed transparent support (10) creating bands (B1 i; B2i; with i=1 . . . n) that implement an autostereoscopic barrier (B1; B2).

2. The method according to claim 1, comprising the step of performing an anti-reflection treatment of said areas (11 a; 11 b) with lower transmittance (TR_11) and/or on said unprocessed transparent support (10).

3. The method according to claim 1, wherein said step of performing a laser-incision on said un processed transparent support (10) using a pulsed laser beam (21) performs parallel incisions, creating parallel bands (B1 i; B2i) that implement said autostereoscopic system (B1; B2).

4. The method according to claim 1, wherein said step of performing a laser-incision on said un processed transparent support (10) using a pulsed laser beam (21) performs incisions on a first face (10a) of the un processed transparent support (10).

5. The method according to claim 1, wherein said step of performing a laser incision carried out on said un processed transparent support (10) using a pulsed laser beam (21) performs incisions inside the transparent support (10).

6. The method according to claim 1, wherein said step of performing a laser incision on said unprocessed transparent support (10) using a pulsed laser beam (21) is carried out as a function of predefined design values of first dimensions (d1) of said lower transmittance areas (11 a; 11 b) and of second dimensions (d2) of distances between said lower transmittance areas (11 a; 11 b).

7. The method according to claim 1, wherein said step of performing a laser incision is carried out with the emission of said pulses at intervals of time in the order of femtoseconds.

8. The method according to claim 1, wherein said areas (11) with lower transmittance (TR_11) have a transmittance in the range of 30% to 50% of the transmittance (TR_10) of said unprocessed transparent support (10), preferably of 50%.

9. The method according to claim 1, wherein said step of providing an unprocessed transparent support (10) is carried out by providing a transparent support made of an amorphous polymeric material or a glass material.

10. The method according to claim 1, wherein said autostereoscopic system (81) is a parallax barrier.

11. The method according to claim 10, wherein said parallax barrier (81) has substantially vertical bands.

12. The method according to claim 10, wherein said areas (11 a) with lower transmittance (TR_11) are characterized by a first thickness (sp1) that is smaller than a second thickness (sp2) of said unprocessed transparent support (10).

13. The method according to claim 1, wherein said autostereoscopic system (82) is a lenticular barrier.

14. The method according to claim 13, wherein said lenticular barrier (82) has slanted bands.

15. The method according to claim 13, wherein said areas (11 b) with lower transmittance (TR_11) are characterized by a third minimum thickness (sp3) that is smaller than the second thickness (sp2) of the unprocessed transparent support (10).

16. A system for performing a support for 3D transmission, comprising:
an unprocessed transparent support (10);
a laser-incising device (20), configured to incise said transparent support (10), creating a plurality of areas (11 a; 11 b) with lower transmittance (TR_11), with respect to a transmittance (TR_10) of said unprocessed transparent support (10);
a processing unit (30) configured to control said laser-incising device (20) so as to drive said pulsed laser beam (21) in such a manner that incising into said unprocessed transparent support (10), gives rise to areas (11 a; 11 b) with lower transmittance (TR_11) with respect to a transmittance (TR_10) of said un processed transparent support (10), the alternation of said areas (11) with lower transmittance (TR_11) and said unprocessed transparent support (10) creating bands (81i; 82i) that implement an autostereoscopic barrier (81; 82).

17. The system according to claim 16, wherein said processing unit (30) is configured to drive said laser beam (21) as a function of predefined design values of first dimensions (d1) of said lower transmittance areas (11) and second dimensions (d2) of distances between said lower transmittance areas (11).

18. The system according to claim 16, wherein said unprocessed transparent support (10) is one of a display of a cellular phone, a tablet or the like, or one of a screen for a PC, a TV or the like.

19. A transparent support (10) comprising:
a plurality of areas (11 a; 11 b) with lower transmittance (TR_11), with respect to a transmittance (TR_10) of said transparent support when it is unprocessed (10), the alternation of said areas (11 a; 11 b) with lower transmittance (TR_11) and said un processed transparent support (10) creating bands (B1 i; B2i; i=1 . . . n) that implement an autostereoscopic barrier (B1; B2).

20. The transparent support (10) according to claim 19, comprising said plurality of areas (11 a; 11 b) with lower transmittance (TR_11) on one face (10a) of the unprocessed transparent support (10).

21. (canceled)

22. (canceled)
